(19) United States
(12) Patent Application Publication
(10) Pub. No.: US 2004/0207638 A1
(43) Pub. Date: Oct. 21, 2004

(54) Cool wave

(75) Inventor: Antonio Fernando Melo e Silva, Lousado (PT)

Correspondence Address: Antonio Fernando Melo e Silva, Rua da Circulacao, 150 - Lousado, V.N. Famalicao, 4760-621, PT

(73) Assignee: Antonio Fernando Melo e Silva, V.N. Famalicao (PT)

(21) Appl. No.: 10/774,274

(22) Filed: Feb. 9, 2004

(30) Foreign Application Priority Data
Apr. 14, 1998 (PT) 08D/AR/DC

(51) Int. Cl. G09G 5/00

(52) U.S. Cl. 345/619

(57) ABSTRACT

My invention “COOL WAVE” is design of a geometric figure, this figure can be used itself or combined with itself (two or more combination), in the same size or different sizes, in a lot of different position; resulting in graphic symbols, patterns, logos and others new designs.

### CROSS REFERENCE TO RELATED APPLICATIONS

“COOL WAVE”, has many applications, when combined with two or more “COOL WAVE” with the same size or different sizes, in the same harmony (proportion sizes), will result in patterns, graphic symbols, logos and other things, which can be used in textiles, publicity, ceramics and other industries.

### BACKGROUND OF THE INVENTION

“COOL WAVE” is a geometric figure, created from a computer programme, belonging to the Class 345—Computer Graphics Processing, and the Subject Matter for this invention is a Utility Patent, which is more adequate.

The invention “COOL WAVE” was emerged in 1997, with the programme Paint Brush in Windows 3.11, later in 1998, I renewed the design in the programme Paint of Mac OS 8.6 and I have registered with S.P.A. (Society Portuguese Authors) with the reg. N° 08D/ARIDC in 04\14∴1998 with the name “OVO” (egg). “COOL WAVE” appears inside the egg in the middle. I have made a petition to register the alphabet, conceived with the design “COOL WAVE” in Portugal by the (I.N.P.I.) and have made a petition to register the alphabet and a lot of patterns, conceived with the design “COOL WAVE” in C.E.E. to the (O.H.I.M.).

### BRIEF SUMMARY OF THE INVENTION

“COOL WAVE” is a geometric figure, which could be used by itself or combined with itself in a lot of positions, to create new designs.

### BRIEF DESCRIPTION OF THE DRAWINGS

I have drawn seven figures to confirm the applications of my invention:

FIG. 1.1 is a “COOL WAVE” only, in two different sizes.

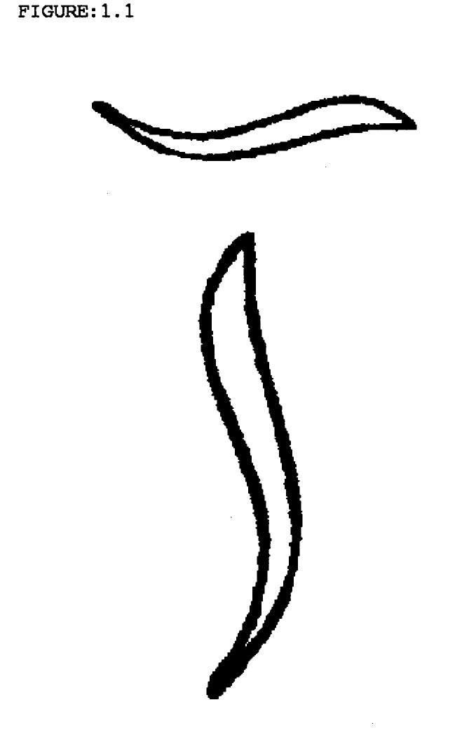

FIG. 1.2 is a pattern, which employs “COOL WAVE” with the same size.

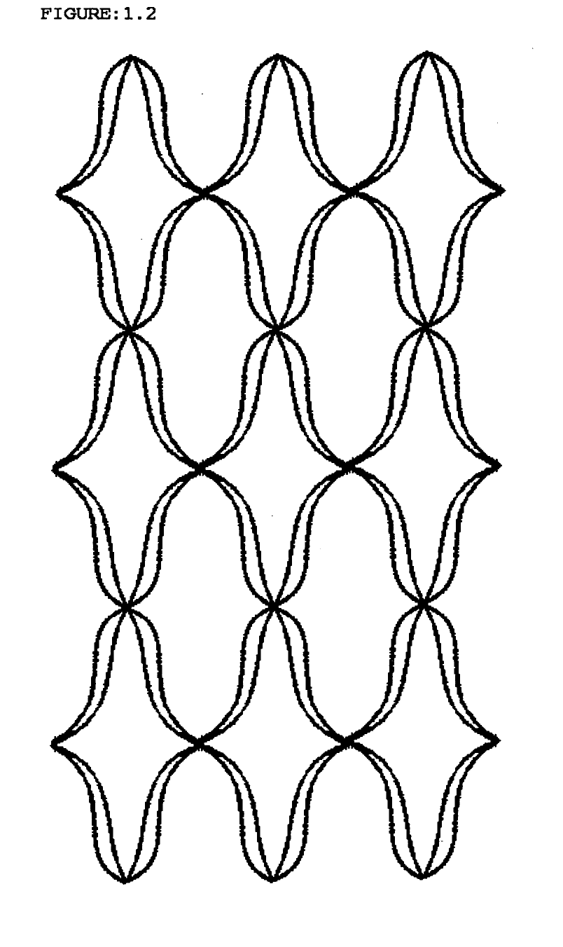

FIG. 1.3 is a pattern, which employs “COOL WAVE” with the same size.

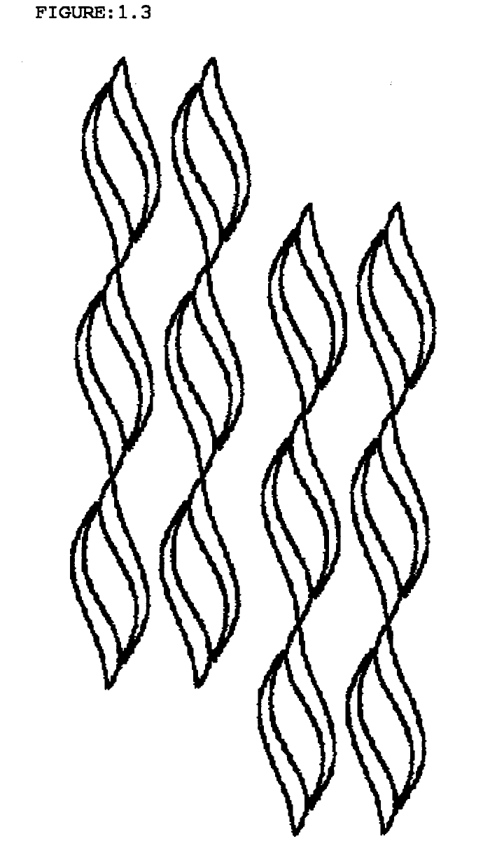

FIG. 1.4 is a graphic symbol, prints “A”, which employs “COOL WAVE” with a different sizes.

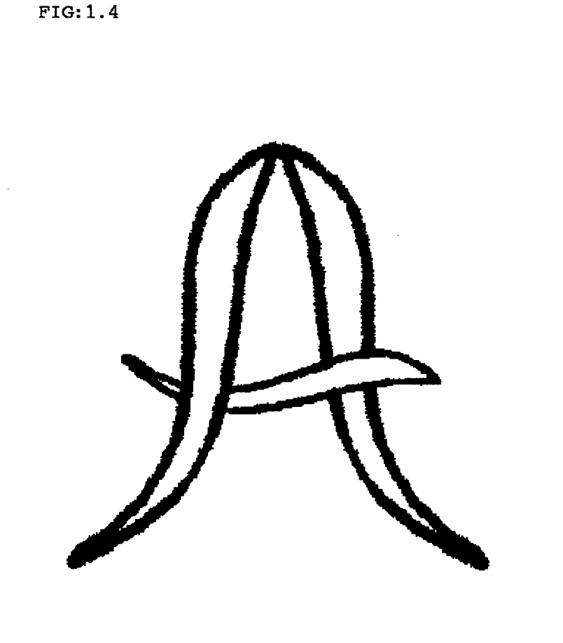

FIG. 1.5 is a graphic symbol, prints “F”, which employs “COOL WAVE” with a different sizes.

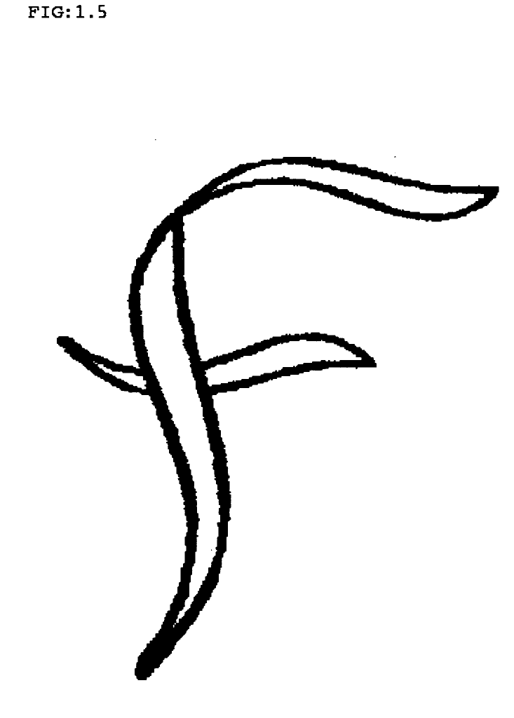

FIG. 1.6 is a graphic symbol, prints “M”, which employs “COOL WAVE” with a different sizes.

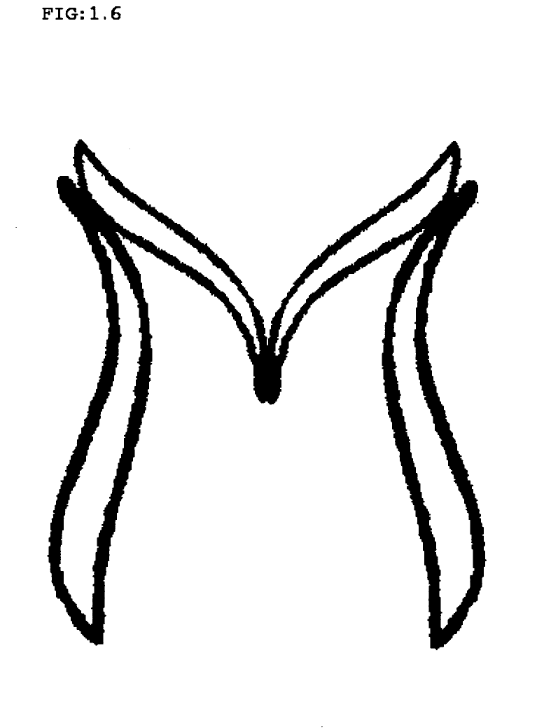

FIG. 1.7 is a graphic symbol, prints “S”, which employs “COOL WAVE” with the same sizes.

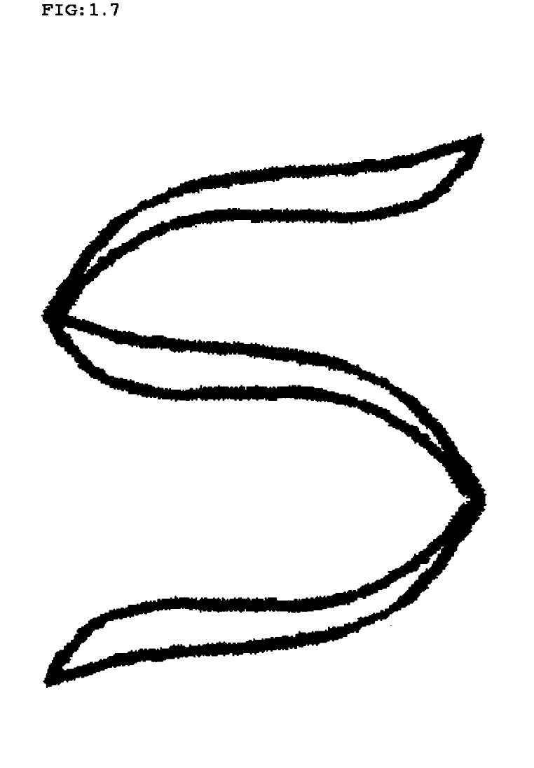

### DETAILED DESCRIPTION

“COOL WAVE” is a geometric figure, with two lines sinusoidal; the lines intersect on the initial point and intersect also in the closure. The figure is billed on the two extremities.

1. I claim a Utility Patent for my invention “COOL WAVE”, under the CLASS 345—COMPUTER GRAPHICS PROCESSING, protected by the Subclass 619—Graphic manipulation.

2. I claim a Utility Patent for my invention “COOL WAVE” under the CLASS 345—COMPUTER GRAFHICS PROCESSING, protected by the Subclass 629—Merge or Overlay.

3. I claim a Utility Patent for my invention “COOL WAVE”, under the CLASS 345—COMPUTER GRAPHICS PROCESSING, protected by the Subclass 630—Combining Model Representation.

4. I claim a Utility Patent for my invention “COOL WAVE”, under the CLASS 345—COMPUTER GRAPHICS PROCESING, protected by the Subclass 634—Image based.

5. I claim a Utility Patent for my invention “COOL WAVE”, under the CLASS 345—COMPUTER GRAPHICS PROCESSING, protected by the Subclass 636—Character and Graphics.

6. I claim a Utility Patent for my invention “COOL WAVE”, under the CLASS 345—COMPUTER GRAPHICS PROCESSING, protected by the Subclass 649—Rotation.

7. I claim a Utility Patent for my invention “COOL WAVE”, under the CLASS 345—COMPUTER GRAPHICS PROCESSING, protected by the Subclass 650—Graphical user interface tools.

8. I claim a Utility Patent for my invention “COOL WAVE”, under the CLASS 345—COMPUTER GRAPHICS PROCESSING, protected by the Subclass 685—Alphanumeric.
